(19) United States
(12) Patent Application Publication
(10) Pub. No.: US 2026/0138098 A1
(43) Pub. Date: May 21, 2026

(54) Self-Assembled Ionic Liquid Layer

(71) Applicant: National Technology & Engineering Solutions of Sandia, LLC, Albuquerque, NM (US)

(72) Inventors: Stephen Percival, Albuquerque, NM (US); Erik David Spoerke, Albuquerque, NM (US); Susan Rempe, Albuquerque, NM (US); Danielle Richards, Albuquerque, NM (US); Calen John Leverant, Albuquerque, NM (US)

(21) Appl. No.: 18/951,100

(22) Filed: Nov. 18, 2024

(51) Int. Cl. B01D 69/14; B01D 71/02; B01D 71/50; B01D 71/68

(52) U.S. Cl. CPC B01D 69/1411; B01D 71/025; B01D 71/027; B01D 71/50; B01D 71/68; B01D 2325/02831; B01D 2325/02832; B01D 2325/02833

(57) ABSTRACT

A method is described whereby a thin, self-assembled ionic liquid layer (SAILL) is produced through careful consideration of surface functionalization of a nanoporous membrane and solution additions. As an example, an EMIM-TFSI ionic liquid layer was produced in the nanopores of a selectively functionalized alumina membrane. The membrane surface functionality controls where the SAILL is located and ultimately, its thickness.

### FEDERALLY SPONSORED RESEARCH AND DEVELOPMENT

This invention was made with Government support under Contract No. DE-NA0003525 awarded by the United States Department of Energy/National Nuclear Security Administration. The Government has certain rights in the invention.

### BACKGROUND OF THE INVENTION

There is a need for thin layers of ionic liquids (IL, a salt in the liquid state) as certain ILs possess unique properties useful for various advanced functional materials. One such application is in chemical separations and purification using separation membranes. In this process, chemicals, such as gaseous CO₂ molecules or rare-earth ions, can transport from one phase (gas or immiscible liquid) into and through the IL and out to the other side of the separation membrane. However, IL phases (at ambient temperatures) tend to be viscous and transport through them is slow. Therefore, making the IL layer as thin as possible (while maintaining the IL layer integrity) would increase the transport rate and also reduce the amount of costly ILs used in the membrane.

### SUMMARY OF THE INVENTION

The present invention is directed to a method for self-assembly of an ionic liquid layer, comprising providing a nanoporous membrane; selectively functionalizing the pores of the nanoporous membrane to provide a polar surface region and a non-polar surface region; filing the pores of the polar surface region with a first solution of a first precursor salt, comprising a first ion of the ionic liquid, in a first polar solvent; adding a second solution of a second precursor salt, comprising an oppositely charged second ion of the ionic liquid, in a second polar solvent, to the filled pores of the polar surface region, whereby the first and second ions undergo a metathesis reaction, thereby forming a separate non-polar ionic liquid phase which self-assemblies to form an ionic liquid layer within the non-polar surface region of the nanoporous membrane. The nanoporous membrane can comprise a nanoporous inorganic oxide, nanoporous polymer, metal-organic framework, or zeolite. The first and/or second polar solvent can comprise water, a carboxylic acid, or an amide. One of the precursor salts can comprise a cation selected from the group consisting of alkyl-substituted imidazolium, pyridinium, piperidinium, pyrrolidinium, quaternary ammonium, and quaternary phosphonium. The other precursor salt can comprise an anion selected from the group consisting of triflate, tetrafluoroborate, hexafluorophosphate, alkyl-phosphonate, and sulfonimide.

### BRIEF DESCRIPTION OF THE DRAWINGS

The detailed description will refer to the following drawings, wherein like elements are referred to by like numbers.

FIG. 1 is a schematic illustration of a thin self-assembled ionic liquid layer (SAILL) within a nanoporous membrane.

FIG. 2 is a schematic illustration of the surface functionalization of a nanoporous alumina membrane after hydrophobic silane and hydrophilic UV/ozone or O₂ plasma treatments.

FIGS. 3A-3D are pictures of Solutions A and B mixed together and their eventual phase separation as the IL phase forms and coalesces. FIG. 3A shows the solutions just mixed. FIG. 3B shows a IL droplet forming. FIG. 3C shows the IL droplet formed and solution cloudiness dissipates as IL emulsion coalesces into an immiscible larger droplet. FIG. 3D is an enlargement with a dashed circle drawn approximately on the IL droplet phase.

FIG. 4 is a schematic illustration of the SAILL process within the pores of the membrane. For clarity the counter ions of the IL precursors are not shown.

FIG. 5 is a schematic illustration of an electrochemical impedance measurement setup where the gold-coated nanoporous membrane is in (Au side down) contact with the gold-coated silicon wafer and a needle-type electrode contacting the gold-coated silicon wafer and another needle-type electrode contacting an aqueous droplet of the ionic solution on top of the nanoporous membrane.

FIG. 6 shows an impedance measurement taken at 0.1Hz of the gold-coated membrane illustrated in FIG. 5, measuring the impedance response over time and the impedance change as Solution B is added to the hydrophobic membrane filled with Solution A.

FIGS. 7A and 7B are BODE impedance spectroscopy plots of the nanoporous membrane, showing that before the SAILL is formed, the impedance is many orders of magnitude larger than after it is formed. Additionally, the high impedance air gap leads to a very noisy EIS spectrum, while the IL-filled pores shows a trace that is not noisy, due to the completed electrical circuit that is easier to measure.

FIG. 8 is a cryo-SEM of an IL-filled nanoporous membrane.

FIG. 9 shows cryo-SEM/EDS maps of the cross section of the SAILL-modified nanoporous membrane. The S-and F-containing ionic liquid layer is located near the lower gold electrode, while the Cl is located above the ionic liquid layer, indicating that the ionic liquid layer has spontaneously formed and that the remaining LiCl salt remains in the aqueous layer above the ionic liquid.

### DETAILED DESCRIPTION OF THE INVENTION

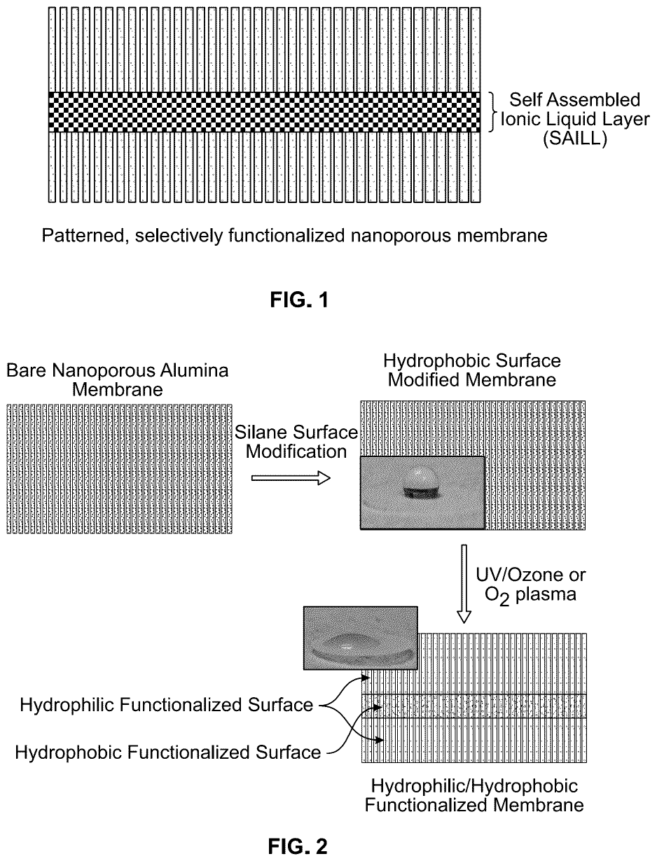

The present invention is directed to a method to make a thin self-assembled ionic liquid layer (SAILL) within a nanoporous membrane. A schematic illustration of a functionalized nanoporous membrane with a thin, internal SAILL layer is shown in FIG. 1. The pores of the membrane can be anisotropic and extend (either directly or through a network) transversely through the membrane thickness. The pores can be chemically or physically modified to define distinct surface regions of polar (e.g., hydrophilic) or non-polar (e.g., hydrophobic) solvent affinity. In this method, the IL molecular constituents are first dissolved into separate solutions as the cations and anions of different soluble salts. When these solutions are mixed within the transmembrane pores, the large IL cations and anions interact in solution and undergo a metathesis reaction (or double displacement reaction) where the counter ions exchange and the IL coalesces into a separate non-polar (e.g., hydrophobic) IL phase. The self-assembly and retention of a thin layer of the IL within the nanoporous membrane is directed by a combination of IL immiscibility, relative IL/solvent density, and IL affinity for the modified (e.g., non-polar or hydrophobic) nanopore wall.

In general, a wide variety of nanoporous membrane materials can be used, including nanoporous inorganic oxides, such as alumina, titania, or silica; nanoporous polymers, such as polycarbonate or polyether sulfone; and metal-organic frameworks (MOFs) or zeolites, so long as the nanoporous membranes can be selectively functionalized to have patterned polar and non-polar regions. Preferably, the pore size is about 100 nm or less in diameter.

The IL is formed by mixing two different solutions of two different precursors salts which contain oppositely charged ions of the ionic liquid salt. A first solution contains a first precursor salt comprising a first ion (i.e., an anion or cation) of the ionic liquid in a first polar solvent, while a second solution contains a second precursor salt comprising the oppositely charged second ion (i.e., the cation or anion) of the ionic liquid in a second polar solvent. Water, a highly polar solvent, is used to dissolve both precursor salts in the following examples. However, those skilled in the art will appreciate that other polar solvents can be used, so long as the precursor salts are soluble in the polar solvent(s), but the resulting IL is not. For example, carboxylic acids, such as ethanoic acid, and amides, such as dimethylformamide, are other polar solvents can also be used to dissolve the precursor salts. Many ionic liquids can utilize this process so long as they form an immiscible non-polar liquid phase that separates to a functional degree from the parent, polar solvent. In particular, salts based on organic cations can be liquid at room temperature. For example, the cation can be a alkyl-substituted imidazolium, pyridinium, piperidinium, pyrrolidinium, quaternary ammonium, or quaternary phosphonium cation. For example, the anion can be triflate, tetrafluoroborate, hexafluorophosphate, alkyl-phosphonate, or sulfonimide anion.

### Example: Functionalization of a Nanoporous Alumina Membrane

As an example of the invention, FIG. 2 shows a schematic illustration of an exemplary nanoporous alumina membrane that first undergoes a silane surface chemistry treatment to make the pores hydrophobic along the entirety of their surfaces. This process can be done in a solution or vapor phase surface modification step via a chemical (e.g., priming with a hydrophobic silane, such as hexamethyldisilazane, HMDS) or physical (e.g., ultrafine nanotexturing of the pore walls) process or some combination of these processes. An example of a hydrophobic surface-modified membrane is shown in the image inset of this step. The image inset also shows a water droplet with a high contact angle, indicating a hydrophobic functionalized surface. Next, a UV/ozone or oxygen plasma treatment can be used to degrade the silane surface functionalization, making the nanopore surfaces hydrophilic again selectively in the nanopore regions where hydrophilicity is desired. The image inset of this step shows a water droplet with low contact angle on the UV/Ozone-treated region of the membrane, indicating a hydrophilic functionalized surface. The plasma treatment can be controlled through the exposure time, whereby an interior region of the nanoporous membrane remains hydrophobic. Therefore, the thickness of this internal hydrophobic surface region can be controlled, which will guide subsequent SAILL assembly and determine the final thickness of the internal IL layer. In general, the hydrophilic surface region needs to be sufficiently hydrophilic to allow pore filling with the polar solvent of choice (e.g., water). Likewise, the hydrophobic surface region needs to be sufficiently hydrophobic to facilitate segregation of the hydrophobic IL.

### Example: Self-Assembly of EMIM-TFSI Ionic Liquid Layer

As an example, a hydrophobic EMIM-TFSI IL [EMIM=1-ethyl-3-methylimidazolium, TFSI=bis(trifluoromethane)sulfonimide] was assembled using a precursor lithium salt of Li-TFSI, which has the TFSI⁻ anion, in a first aqueous solution (Solution A), and a precursor chloride salt of EMIM-Cl, which has the EMIM⁺ cation, in a second aqueous solution (Solution B). Both of these precursor salts are very soluble in water but when they are mixed together the ions exchange through a metathesis (double displacement) reaction and form the EMIM-TFSI IL. The lithium chloride (LiCl) remains dissolved in the water while the hydrophobic EMIM-TFSI IL coalesces and phase separates from the water.

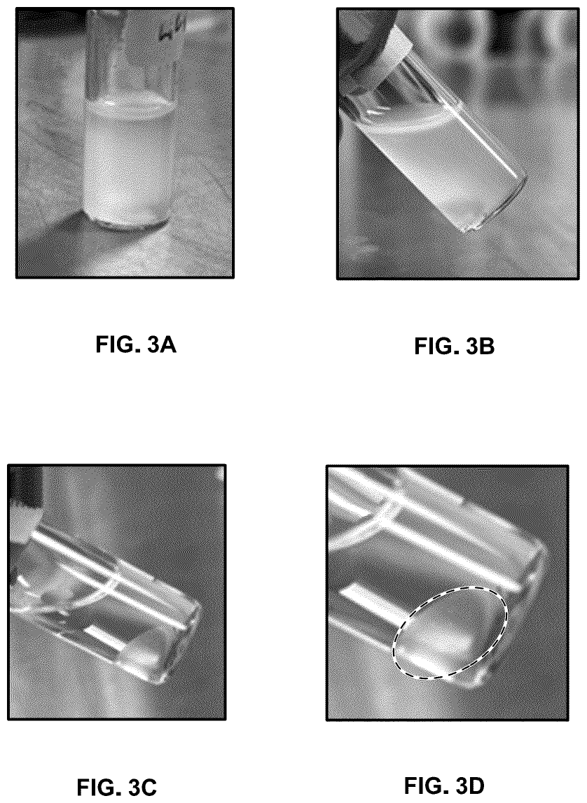

Ionic liquid formation is shown in FIGS. 3A-3D. In FIG. 3A, the two aqueous solutions (Solutions A and B) were mixed together (each solution had a 1 M concentration of the precursor salts) in a vial and immediately the solution turned cloudy. This indicates that there are nano-droplets of the immiscible IL forming an emulsion. The nano-droplets will begin to fuse together and merge, eventually growing into a large, immiscible droplet that can be seen forming in the bottom of the vial in FIG. 3B. Finally, the IL droplet is fully formed and the remaining aqueous solution containing the dissolved LiCl becomes clear again, as shown in FIG. 3C. FIG. 3D is and enlargement of FIG. 3C, with a dashed circle drawn around the IL droplet at the bottom of the vial.

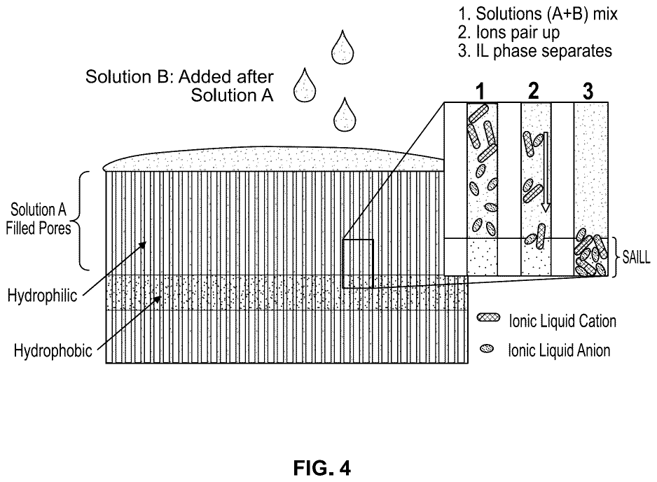

The above-described metathesis reaction can generate the hydrophobic IL phase but a patterned, selectively functionalized nanoporous membrane is needed produce the thin SAILL. FIG. 4 illustrates this guided self-assembly process in which the nanoporous membrane has been selectively functionalized to provide an internal hydrophobic surface region, as described above. Solution A (containing the IL anion in this example) is first added to the patterned nanoporous membrane and fills the hydrophilic pores down to the hydrophobic surface region. Then, Solution B (containing the IL cation in this example) is slowly added to the top of the filled membrane. Solution B will begin mixing with Solution A inside the pores (as seen in step 1 in the FIG. 4). The paired IL ions will then begin to coalesce and, due to their higher density than water, sink and phase separate in the hydrophobic region, forming a SAILL in the hydrophobic region (as seen in steps 2 and 3 of FIG. 4, respectively). This process takes advantage of the high density of the EMIM-TFSI IL, which causes the IL to sink to the bottom of the water-filled pores, eventually filling the hydrophobic region. However, a similar phase separation can be achieved with a low density IL that would rise to the water's surface. In this case, Solution A could just be filled in a hydrophilic region at the bottom of the pores and instead of adding Solution B to the top of the membrane (or a top-filled membrane can be flipped over), the membrane would be placed on a drop of Solution B, allowing the two solutions to mix in the pores at the bottom of the membrane, with the miscible IL rising in the water-filled pores, again to an upper hydrophobic-modified region.

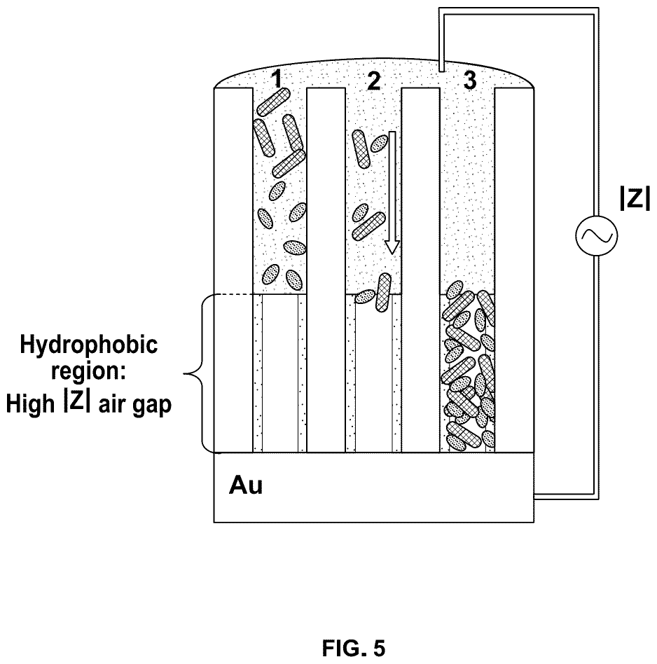

As an example, the SAILL method was used to produce EMIM-TFSI IL-filled nanoporous alumina membranes (with 100 nm diameter pores). Electrochemical impedance spectroscopy (EIS) was performed to interrogate the filling of the membranes to verify the successful formation of the IL layer. To do this, the patterned membranes were coated with 500 nm of gold and placed on a gold-coated silicon wafer after a HMDS hydrophobic treatment and a subsequent UV/ozone treatment, which made the upper region of the pores hydrophilic but left a hydrophobic region at the bottom of the pores. A needle-type contact electrode was touched to the gold-coated silicon wafer and another needle-type electrode was placed where it would be immersed (in contact) with an aqueous droplet of 1 M Li-TFSI containing liquid (Solution A) at the top of the membrane, as illustrated in FIG. 5. This liquid will wet and fill the top of the pores where it is hydrophilic but will not fill all the way down into the pores due to the remaining hydrophobic surface modification at the bottom of the pores. Because the aqueous solution will not completely fill the pores, the electrical circuit is not completed and the resulting impedance is extremely high (due to the air gap in the hydrophobic region). A drop of Solution B (containing 1 M EMIM-Cl) is then added to the top of the membrane, as shown in step 1 of FIG. 5. The IL ions will pair up (step 2) and the IL will spontaneously phase separate from the aqueous phase and, since the density of the EMIM-TFSI IL is higher than water, will fall down into hydrophobic region of the pores (step 3), completing the electrical circuit and leading to a change in the measured impedance response.

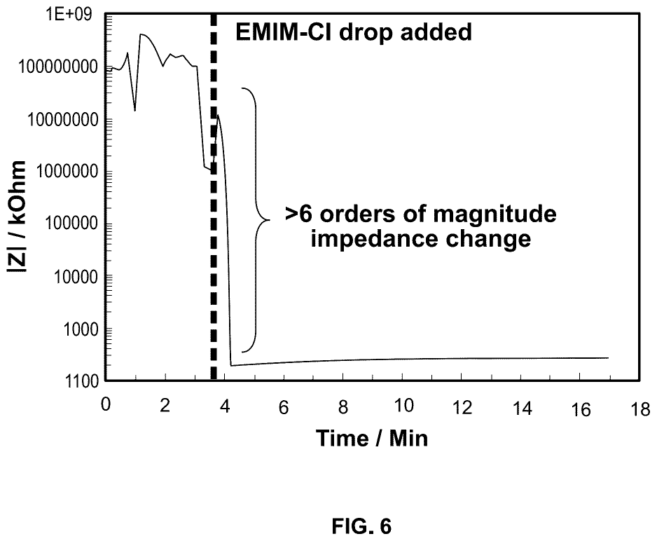

FIG. 6 shows an impedance measurement over time (measured at 1 Hz) of a Au-coated membrane as illustrated in FIG. 5. Initially, the impedance is very high, on the order of 10⁸-10⁹ kOhm (0.1-1.1 GOhm). Additionally, the data is noisy with large impedance fluctuations. This is due to the open circuit nature in which the impedance is measuring an air gap within the nanopores and is sensitive to minor fluctuations in the laboratory environment. At ˜4 minutes into the data recording, an aqueous droplet containing Solution B of the IL pair (i.e., EMIM-Cl) is added to the top of the membrane. Very quickly, a change in the membrane impedance is observed as the EMIM-TFSI IL spontaneously forms and fills the hydrophobic region at the bottom of the pores. This leads to a greater than 6 order of magnitude decrease in the measured impedance, down to 200-300 kOhm. Additionally, the impedance trace over time becomes very stable and is much less noisy than when the hydrophobic pores are not filled with IL.

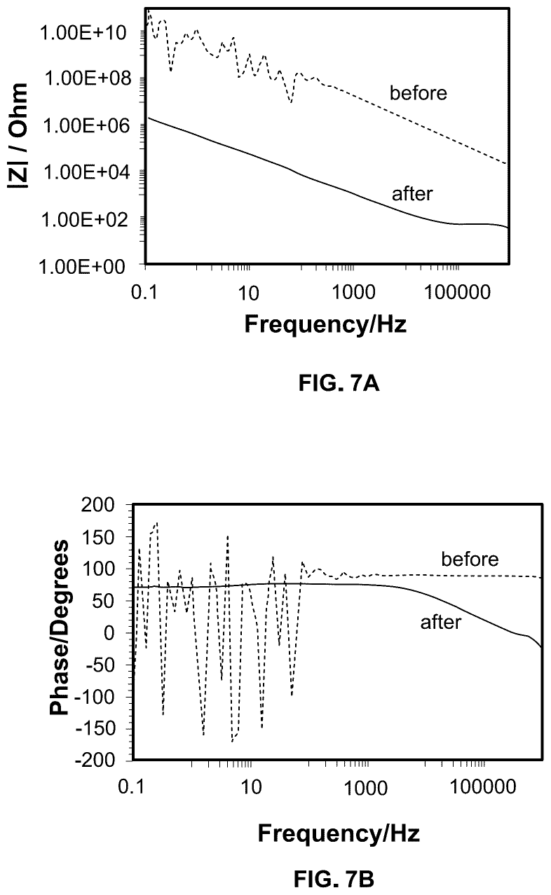

FIGS. 7A-7B show Bode plots of the impedance magnitude (FIG. 7A) and phase angle (FIG. 7B) as a function of the AC frequency, from the Au coated membrane before and after the spontaneous segregation of the IL layer filling the pores and completing the circuit. As shown in FIG. 7A, the EIS from the gold-coated membrane before the hydrophobic region is filled with IL has a much higher impedance at all frequencies. At lower frequencies, the EIS trace becomes much more noisy, similar to the impedance vs time behavior seen in FIG. 6. However, after the IL layer fills the hydrophobic pores and completes the circuit, the impedance at all frequencies decreases, by more than 6 orders of magnitude at low frequencies. The impedance at high frequencies shows a somewhat smaller decrease, with a small plateau at the highest frequencies where the membrane would have a small RC time constant, also confirming the completion of the electrical circuit. As shown in FIG. 7B, the phase angles for each case, before and after IL filling of the hydrophobic pores, show very different behavior from each other. The phase angle for the unfilled pores starts at ˜90 degrees at high frequencies and more or less stays at that value for all frequencies, with the phase angle getting much noisier at low frequencies with very large fluctuations in values, similar to the impedance plots in FIG. 7A. The phase angle for the filled membrane indicates a small RC time constant, as it starts at 0 degrees at the beginning of the scan at 1 MHz. The filled membrane phase angle then increases towards 90 degrees as the frequency is decreased and eventually reaches a maximum at ˜1000 Hz which is probably due to the fact that the ions in the solution-filled pores cannot transport through the Au at the bottom of the electrode and are not capable of electronic conductivity.

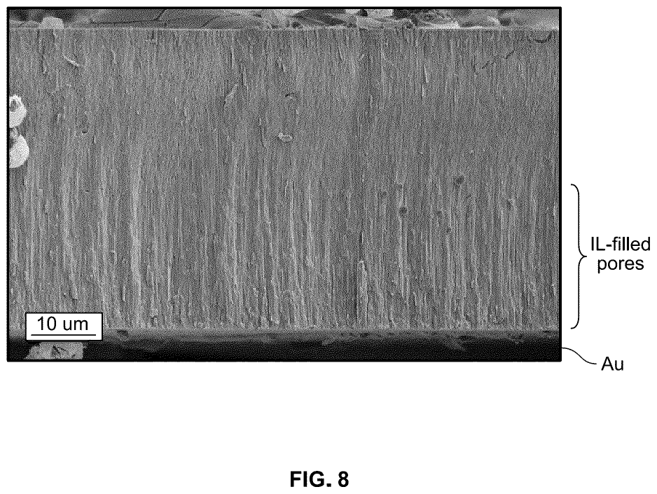

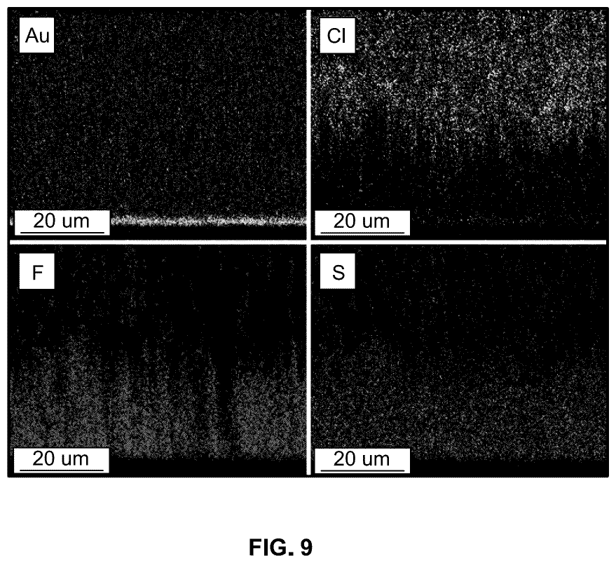

FIG. 8 shows a cryogenic scanning electron microscopy (cryo-SEM) image of the cross section of a IL/water filled nanoporous membrane after the spontaneous IL layer formation. The membrane was frozen using liquid nitrogen and imaged using a cryogenic stage cooled to −150° C. After freezing the membranes, they were fractured while frozen to reveal the layers within the membrane. The membrane pores appear filled with IL and ice or solid salts. The Au electrode is located at the bottom of the membrane in the SEM and the IL/water interface is located within the membrane above the Au layer. The IL/water interface can't be clearly seen in the conventional SEM image. Therefore, energy-dispersive X-ray spectroscopy (EDS) elemental mapping was used to resolve the interfaces. FIG. 9 shows the EDS mapping of the cross section for Au, Cl, F and S elements. After the IL phase separates, the Cl remains in the upper water layer (as dissolved LiCl), so the IL layer/water interface is apparent where the S and F elements (IL phase) meet the Cl (water phase) in the maps. From the EDS maps it can be seen that the IL forms a uniform layer above the Au and has a clear separation from the upper Cl layer, confirming the spontaneous formation of the IL layer that fills the lower hydrophobic region of the nanopores.

This process of creating an intentionally engineered interface or liquid phase partition can have far reaching applications beyond chemical separations, such as in energy storage or catalysis, by imparting desired physical properties at the solid electrode-electrolyte interface, or even in gas or liquid phase chemical sensors.

The present invention has been described as a self-assembled ionic liquid layer. It will be understood that the above description is merely illustrative of the applications of the principles of the present invention, the scope of which is to be determined by the claims viewed in light of the specification. Other variants and modifications of the invention will be apparent to those of skill in the art.

1. A method for self-assembly of an ionic liquid layer, comprising:
providing a nanoporous membrane;
selectively functionalizing the pores of the nanoporous membrane to provide a polar surface region and a non-polar surface region;
filing the pores of the polar surface region with a first solution of a first precursor salt, comprising a first ion of the ionic liquid, in a first polar solvent;
adding a second solution of a second precursor salt, comprising an oppositely charged second ion of the ionic liquid, in a second polar solvent, to the filled pores of the polar surface region, whereby the first and second ions undergo a metathesis reaction, thereby forming a separate non-polar ionic liquid phase which self-assemblies to form an ionic liquid layer within the non-polar surface region of the nanoporous membrane.

2. The method of claim 1, wherein the first or second polar solvent comprises water, a carboxylic acid, or an amide.

3. The method of claim 1, wherein the first or second ion comprises a cation selected from the group consisting of alkyl-substituted imidazolium, pyridinium, piperidinium, pyrrolidinium, quaternary ammonium, and quaternary phosphonium.

4. The method of claim 3, wherein the alkyl-substituted imidazolium comprises 1-ethyl-3-methylimidazolium.

5. The method of claim 1, wherein the first or second ion comprises an anion selected from the group consisting of triflate, tetrafluoroborate, hexafluorophosphate, alkyl-phosphonate, and sulfonimide.

6. The method of claim 5, wherein the sulfonimide comprises bis(trifluoromethane)sulfonimide.

7. The method of claim 1, wherein the nanoporous membrane comprises a nanoporous inorganic oxide, nanoporous polymer, metal-organic framework, or zeolite.

8. The method of claim 7, wherein the nanoporous inorganic oxide comprises alumina, titania, or silica.

9. The method of claim 7, wherein the nanoporous polymer comprises polycarbonate or polyether sulfone.

10. The method of claim 1, wherein the pores of the nanoporous membrane are less than 100 nanometers in diameter.
